(19) United States
(12) Patent Application Publication
(10) Pub. No.: US 2004/0064076 A1
(43) Pub. Date: Apr. 1, 2004

(54) External chest therapy blanket for infants

(76) Inventor: Jagadish Bilgi, Ankeny, IA (US)

Correspondence Address: STURM & FIX LLP, 206 SIXTH AVENUE, SUITE 1213, DES MOINES, IA, 50309-4076, US

(21) Appl. No.: 10/259,895

(22) Filed: Sep. 27, 2002

(51) Int. Cl. A61H 23/02

(52) U.S. Cl. 601/149

(57) ABSTRACT

Massaging and compressing the lungs of a patient has been proven effective in loosening mucus buildup. Devices and methods for this purpose have been designed for patients older than infants and toddlers. A method for massaging and compressing the lungs of infants and toddlers has been developed using a device similar to those used for older patients. Such devices use pulsating air to inflate and deflate bladders that are in contact with the patient and apply pressure to the upper torso of the patient. For older patients, the devices are typically made into a vest and fitted on the patient. For infants and toddlers the device, herein called a J-blanket, having the same bladder arrangement is spread flat on a suitable surface and the patient placed on the J-blanket. This reduces the physical trauma to these very young patients. The J-blanket™ can be fitted with sensors to provide important feedback related to the patient's well-being. The same method can be applied to patients of any age that might experience too great a physical trauma when treated in the conventional fashion.

### BACKGROUND OF THE INVENTION

1. Field of the Invention

The present invention relates generally to a method of using a medical a device. More particularly the present invention relates to the use of a device for compressing and massaging the upper torso of patients for the purpose of loosening mucus from the lungs of the patient. It has special application to patients that are young (infants to toddlers), or would experience undo physical trauma undergoing more traditional treatment. Furthermore, this invention has particular application to infants afflicted with cystic fibrosis, pneumonia, asthma, and immature lungs.

2. Background Art

A buildup of mucus in the lungs of a patient whose immune system may be compromised, anyway, can be dangerous and even fatal. Removal of the mucus helps in the functioning of the lungs, and in reducing the chance of infection within the lungs.

A device used presently for the purpose of massaging the lungs is revealed in Warwick et al. U.S. Pat. No. 5,056,505, which is incorporated herein by reference. These present-day devices utilize air to inflate a bladder or bladders and include a vest or sleeveless garment worn on the upper body of the patient. Such a garment has been found to be too bulky for young infant or toddler patients. Young patients—especially prematurely born infants—require specialized equipment for this purpose.

Present-day devices for massaging and compressing the lungs use air, carried to and from the device via air ducts. The air compression system has been found to be too vigorous for very young patients.

For the above reasons, there is a need for a method for massaging the upper torso of a toddler, infant, or even a premature baby. There is also a need for the device used to be driven by an air-pumping system that is (or can be) regulated for infant and toddler human beings.

### SUMMARY OF THE INVENTION

A purpose of this invention is to provide a method to reduce physical trauma, for compressing and massaging a patient's upper torso to loosen a buildup of mucus in the patient's lungs. These patients, in particular are infants or toddlers, but can include anyone for whom traditional lung compression methods provide too much physical trauma.

A further purpose, in conjunction with the above, is to provide an apparatus for modulating pressure pulses to a bladder used in the device for compressing and massaging the patient's upper torso.

Still another purpose of this invention is to provide, in conjunction with the above device for compressing and massaging a patient's upper torso, built-in sensors for the patient's oxygen level, heart rate, and respiration rate.

There are many afflictions for which treatment might include procedures for loosening mucus from the lungs. Such afflictions include premature lungs, pneumonia, cystic fibrosis, and asthma.

The devices presently used for the purpose of massaging and compressing a patient's chest for the purpose of loosening mucus are in the form of a vest. Such a garment is too bulky to put on a young patient such as an infant or toddler, especially a premature infant. The use of a band that wraps around the chest is revealed in the prior art. For small patients, a better approach can be one utilizing a J-blanket™ that the patient lies on—either face up, face down, or on the side. In these cases, the J-blanket need not be wrapped around the infant at all, significantly improving the child's comfort.

The J-blanket is outfitted with multiple chambers, all of which are expanded when filled with air at a higher pressure than atmospheric. Pressure relief valves are also incorporated at various locations on the J-blanket. Alternating expansion and contraction of the chambers produces the desired effect of compressing and massaging the patient's lungs.

An air handling system for the J-blanket is required to carry compressed air to and from the J-blanket. The special needs of very small patients—infants and toddlers—require that the air handling system provide a level of compression and massaging that they can tolerate.

Especially for such young patients, there is a need to monitor critical patient parameters. Sensors can be mounted on or in the J-blanket to monitor the patient's oxygen saturation, heart rate and respiration rate. Because the J-blanket must be in close contact with the patient to serve the purpose of massaging the upper torso, the sensors are, by default, in close contact with the patient. Massaging need not be taking place for the sensors to be active. Therefore, there is advantage to keeping the patient on the J-blanket even when there is not a need to loosen mucus from the lungs.

### BRIEF DESCRIPTION OF THE DRAWINGS

FIG. 1 shows a J-blanket, under a patient, with a system for providing compressed air and readouts for sensors.

FIG. 2 shows a more detailed view of the system for providing compressed air and readouts for sensors.

FIG. 3 shows the side of a J-blanket that faces toward from the patient.

FIG. 4 shows the side of a J-blanket that faces away from the patient.

FIG. 5 shows the annular tubes for handling air to and from the J-blanket.

FIG. 6 shows pressure relief valve.

FIG. 7 shows a sensor mounted in a J-blanket surface.

FIG. 8 shows construction of the material of which J-blanket is made.

FIG. 9 shows a J-blanket™ wrapped around a patient.

### BEST MODE FOR CARRYING OUT THE INVENTION

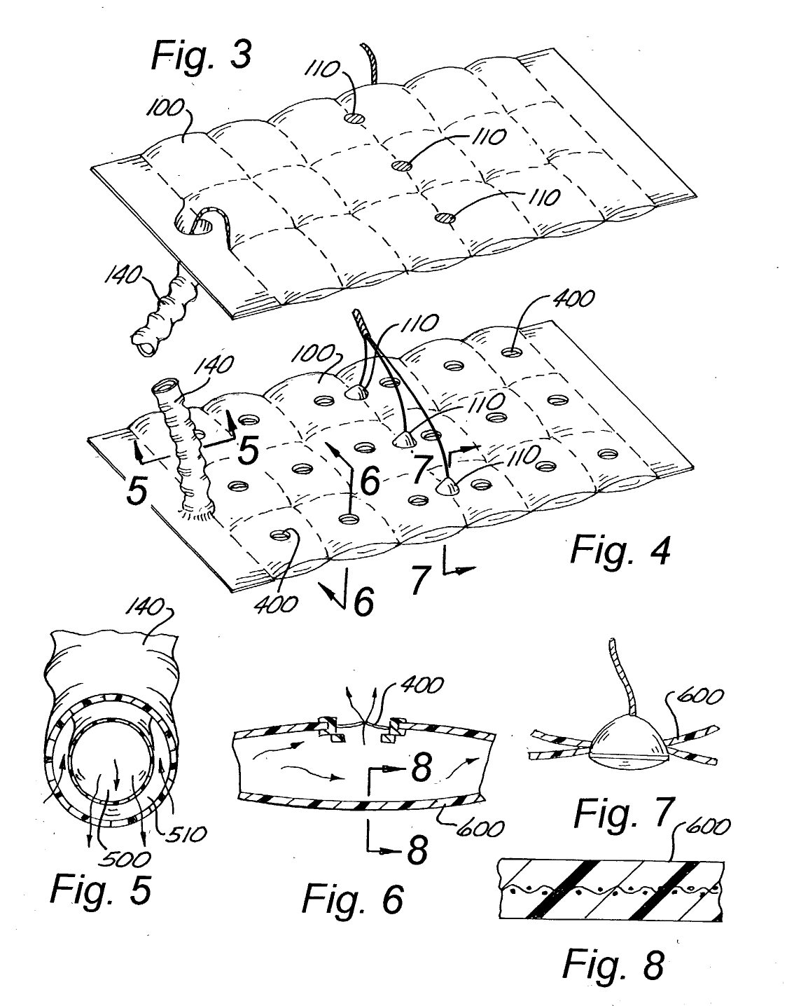

Experience has shown that providing alternating pressure to the chest and upper torso area of patients with a buildup of mucus is effective in reducing that mucus buildup. Accordingly, devices have been in use to effect the massage and compression of the lungs of patients in need of such treatment. To treat small human patients (from premature babies to toddlers) (or any patient for whom traditional lung massage would be too physically traumatic), a device, illustrated in FIGS. 3 and 4 and called a J-blanket for massaging and compressing the lungs can be spread on a surface such as a table or bed and the child placed on the J-blanket.

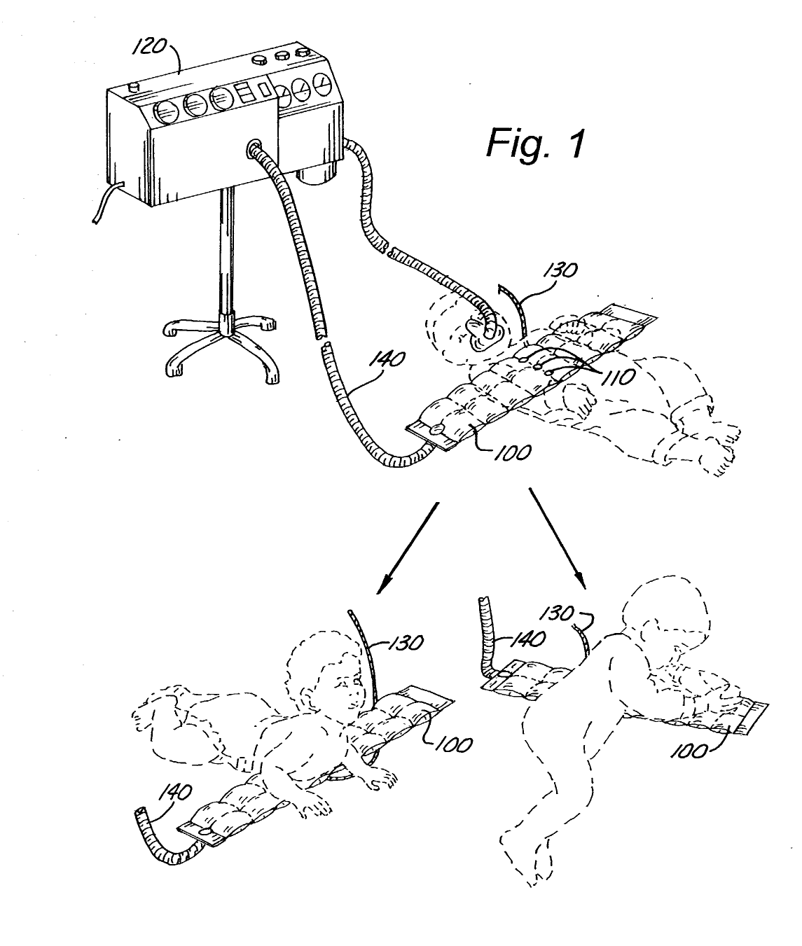

An overview of the lung massaging system is illustrated in FIG. 1. The J-blanket 100 is shown lying flat on a surface. There are three sensors 110 to monitor the patient's oxygen level, heart rate, and respiration rate. These data are transmitted to air-handling unit 120 via wires 130. Pulsating air comes from and returns to the air handling unit via annular hose 140. An important aspect of the method of the present invention is revealed in FIG. 1. A very small, young, human patient may be treated most successfully, with the least physical trauma but lying on the J-blanket rather than wearing a vest.

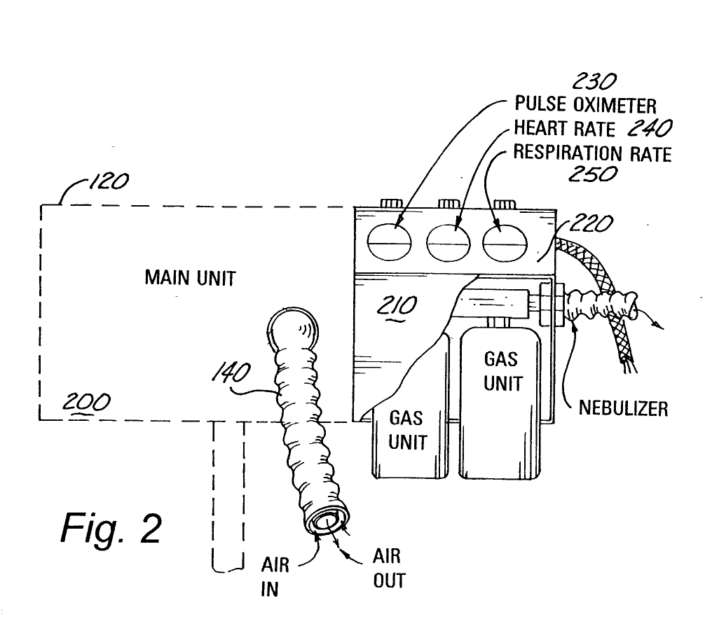

A more detailed view of air handling unit 120 is shown in FIG. 2. Air handling unit 120 is comprised of three separate parts:

1. Main unit 200 provides the compressed and pulsating air for J-blanket 100 via annular hose 140.

2. Respirator unit 210 provides moisturized (and medicated, if necessary) air for the patient's respiration.

3. Monitor unit 220 provides readouts for the sensors 110 mounted on or in J-blanket 100.

Monitor unit 220 has a monitor 230 for oxygen saturation, a monitor 240 for pulse rate, and a monitor 250 for respiration rate.

FIG. 3 shows a view of a J-blanket 100 showing the side facing the patient.

FIG. 4 shows a view of a J-blanket 100 showing the side facing away from the patient. Sensors 110 and annular hose 140 are shown. Sensors 110 are placed in the center of J-blanket 100 so they are in contact with the patient.

Annular hose 140 is detailed in FIG. 5. Air passing from main unit 200 to J-blanket 100 travels in circular center region 500 while air passing from J-blanket 100 to main unit 200 travels in annular region 510. These directions can be reversed and this invention is not limited to either possibility.

A pressure relief valve 400 in J-blanket 100 is shown in FIG. 4 and detailed in FIG. 6.

One of the sensors 110 is shown in more detail in FIG. 7. It is mounted in the material 600 making up J-blanket 100, but it could be mounted on the material 600, or even under it.

FIG. 8 shows details of the material 600 making up J-blanket 100. It is comprised of two layers of material. The first material 800 is for the comfort of the patient so is soft but may not have the strength to sustain the pulsating loads applied to it. The second material 810 is for the strength required to withstand the stresses applied by the pressurized air.

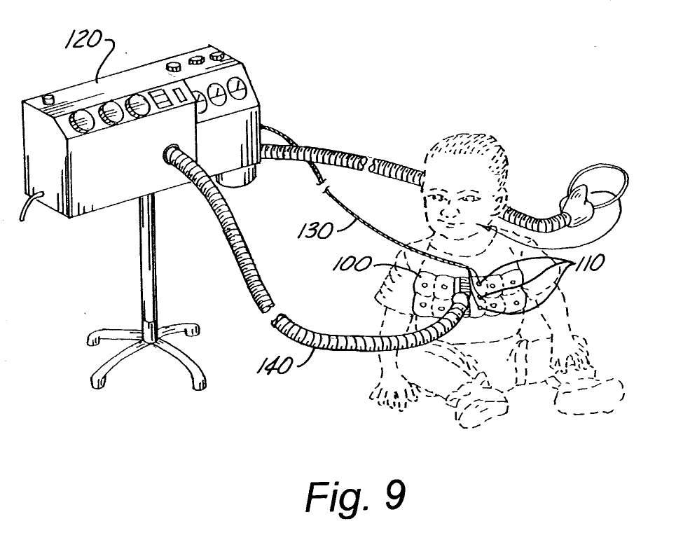

In FIG. 9, the blanket 100 is shown being used more conventionally with it wrapped around the patient's chest. For this usage, hook and loop fasteners like the Velcro® brand of fastener are used at the ends so the blanket 100 can be kept on the patient's chest. Other aspects of the blanket are the same as above. Sensors 110 are connected to the monitor unit 220 via wires 130. The pulsating air is passed to and from the blanket 100 through annular hose 140.

Obviously many modifications and variations of the present invention are possible in light of the above teachings. It is, therefore, to be understood that within the scope of the appended claims, the invention may be practiced otherwise than as specifically described.

I Claim:

1. A method for using a device for massaging and compressing lungs of a patient for the purpose of loosening mucus, the method comprising:
(a) spreading the device for massaging and compressing the lungs of a patient out on a surface; and
(b) laying the patient on the device.

2. The method of claim 1 wherein the patient lies face up.

3. The method of claim 1 wherein the patient lies face down.

4. The method of claim 1 wherein the patient lies on their side.

5. The method of claim 1 wherein the device for massaging and compressing lungs of a human patient is used with sensors for critical health parameters.

6. The method of claim 5 wherein the sensors used include a sensor for measuring oxygen saturation in blood.

7. The method of claim 5 wherein the sensors used include a sensor for measuring pulse rate.

8. The method of claim 5 wherein the sensors used include a sensor for measuring respiration rate.

9. The method of claim 1 wherein pulsating air pressure is sent through an annular hose to the device for massaging and compressing lungs of a human patient.

10. The method of claim 1 wherein the pulsating air pressure is sent from a main unit to the device for massaging and compressing lungs of a human patient, a strength of the pressure pulsations being tempered for infants and toddlers.

11. The method of claim 1 including using the device for massaging and compressing lungs of a patient is flexible and such massaging and compressing is done by causing the to pulsate due to air pressure changes inside of a sealed bladder.

12. An apparatus for massaging and compressing the lungs of a human infant comprising:
a blanket disposed substantially completely on a substantially flat surface, said blanket having at least one sealed chamber therein and adapted to have an infant lie thereon with the infant's chest being in juxtaposition to the sealed chamber of the blanket; and
compressed air means for selectively inflating and deflating the blanket.

13. The apparatus of claim 12 wherein the blanket for massaging and compressing lungs of a human patient includes sensors for critical health parameters.

14. The apparatus of claim 13 wherein the sensors include a sensor for measuring oxygen saturation in blood.

15. The apparatus of claim 13 wherein the sensors include a sensor for measuring pulse rate.

16. The apparatus of claim 13 wherein the sensors include a sensor for measuring respiration rate.
